(19) United States
(12) Patent Application Publication
(10) Pub. No.: US 2007/0247724 A1
(43) Pub. Date: Oct. 25, 2007

(54) Liquid lens with curved contact surface

(75) Inventor: Moon Sik Jung, Goonpo (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/783,233

(22) Filed: Apr. 6, 2007

(30) Foreign Application Priority Data
Apr. 25, 2006 (KR) 10-2006-0037361

(51) Int. Cl. G02B 3/12

(52) U.S. Cl. 359/666

(57) ABSTRACT

A liquid lens having a curved contact surface with inner fluids. The liquid lens is configured to adjust a focal distance using electro-wetting and includes a base having an insulator film formed thereon and connected with an electrode. The liquid lens also includes a first fluid disposed on the base and a second fluid disposed on the first fluid. The liquid lens further includes a cover for hermetically sealing the first and second fluids, the cover connected to the electrode and made of a light-transmitting material. According to the present invention, the curvature of a meniscus between the fluids is allowed to change sensitively or insensitively in response to voltage. This allows application of the liquid lens to various electronic devices and a miniaturized structure with a small thickness.

### CLAIM OF PRIORITY

This application claims the benefit of Korean Patent Application No. 2005-0037361 filed on Apr. 25, 2006, in the Korean Intellectual Property Office, the disclosure of which is incorporated herein by reference.

### BACKGROUND OF THE INVENTION

1. Field of the Invention

The present invention relates to a liquid lens having a curved contact surface of a base with inner fluids and, more particularly, to a liquid lens which has a curved contact surface of a base to allow the contact angle of the fluids to change sensitively or insensitively in response to voltage variation, thereby enabling product designs with various focal distances and a miniaturized structure with a small thickness.

2. Description of the Related Art

In general, electro-wetting occurs when electricity is applied to an insulated electrode to change the surface tension of a liquid, which thereby can wet a material in contact with the liquid. A liquid lens based on such electro-wetting to adjust the focus has been disclosed in the prior art.

FIG. 1 illustrates a conventional liquid lens 200 using electro-wetting. The liquid lens 200 includes an electrolyte 220 disposed on an insulator 210 and an electrode 230 formed underneath the insulator 210. When a current is applied to the electrode 230 and the electrolyte 220, the interfacial angle θ or the contact angle of the electrolyte 220 with the insulator 210 is changed.

That is, when there is a droplet of the electrolyte 220 on a surface of the insulator 210, interfaces are formed between the insulator 210 and the electrolyte 220, the electrolyte and the ambient air 225, and the insulator 210 and the ambient air 225. Among these, the contact angle θ between the electrolyte 220 and the insulator 210 is determined by Young's equation.

γ_{SL}−γ_{SG}=γ_{LG}·COS θ Young's equation

In this equation, S represents the insulator, L represents the electrolyte, G represents the air and γ represents the surface tension coefficient determined by the above components.

Here, after preparing the electrolyte 220 with a conductive fluid and forming an insulator film in contact with the electrolyte, when the voltage is applied to the electrodes 212 and 222 formed in the back of the electrolyte 220 and the insulator 210, the surface tension coefficient changes. Such a surface tension coefficient is in accordance with Lippmann's equation.

γ=γ₀−(½)cV² Lippmann's equation

As described above, the surface tension coefficient changes in accordance with the applied voltage V and the permittivity c of the insulator, and due to such change in the surface tension coefficient, the cosine value of the contact angle θ changes.

Therefore, as seen from the above equations, the cosine value of the contact angle θ is in proportion to the squared value of the applied voltage V.

A conventional liquid lens 300 using such a basic principle is shown in FIG. 2.

The conventional liquid lens includes oil, which is a non-conductive fluid 330 and electrolyte, which is a conductive fluid 350, filled in substantially the same densities in a space provided by transparent substrates 310a and 310b, and an insulator 310 and electrodes 332 and 352 formed outside the substrates 310a and 310b to apply a voltage to the conductive fluid 350.

In this liquid lens 300, adjusting the voltage supplied to the conductive fluid 350 through a transparent metal electrode changes the contact angle θ between the insulator 310 and the conductive fluid 350 as indicated by the dotted line in FIG. 2. Thereby, the meniscus between the electrolyte, i.e., the conductive fluid 350 and the oil, i.e., the non-conductive fluid 330 changes in its shape. This in turn changes the focal distance of the light passing through the meniscus.

Meanwhile, the conventional liquid lens 300 has an inclined planar contact surface in contact with the meniscus between the conductive fluid 350 and the non-conductive fluid 330. With this configuration of the conventional liquid lens 300, no other significant functions are possible except for changing the contact angle θ in response to the voltage variation.

For example, it is not possible to effectively cope with the change of the contact angle θ resulting from the curvature of the meniscus of the fluids changing too quickly or insensitively in response to the voltage change.

If the liquid lens can effectively utilize the change of the contact angle θ in accordance with the curvature of the meniscus formed quickly or insensitively, various designs of focal distances would be possible as well as a thin structure of the lens with a lower height, which however has not been applied to practical development.

### SUMMARY OF THE INVENTION

The present invention has been made to solve the foregoing problems of the prior art and therefore an aspect of the present invention is to provide a liquid lens which has a curved contact surface of a base to allow sensitive or insensitive curvature changes of a meniscus of fluids, thereby applicable to various electronic devices.

Another aspect of the invention is to provide a liquid lens which has a curved contact surface of a base so as to be easily manufactured into a thin structure, thereby achieving miniaturization of a product.

Further another aspect of the invention is to provide a liquid lens which has a curved contact surface to effectively cope with volume changes of fluids, thereby easily obtaining a desired focal distance and enabling various product designs.

According to an aspect of the invention, the invention provides a liquid lens configured to adjust a focal distance using electro-wetting. The liquid lens includes: a base with an insulator film formed thereon and connected to an electrode; a first fluid disposed on the base; a second fluid disposed on the first fluid; and a cover hermetically sealing the first and second fluids and connected to the electrode, the cover made of a light-transmitting material, wherein a contact surface of the base with the first and second fluids is a curved surface.

Preferably, the contact surface is a convex surface.

Preferably, the contact surface is a concave surface.

Preferably, the contact surface is composed of both convex and concave surfaces.

Preferably, the contact surface is composed of both curved and planar surfaces.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a explanatory view illustrating a basic principle of electro-wetting applied to the prior art;

FIG. 2 is a sectional view illustrating a general liquid lens according to the prior art;

FIG. 3 is a sectional view illustrating a convex contact surface of a liquid lens according to the present invention;

FIG. 4 is a sectional view illustrating a concave contact surface of a liquid lens according to the present invention;

FIGS. 5 (a), (b) and (c) are sectional views illustrating the changes in the menisci compared between the prior art and the present invention; and

FIGS. 6 (a) and (b) are sectional views illustrating the structures for effectively coping with the volume changes of the fluids injected into the liquid lens, according to the present invention.

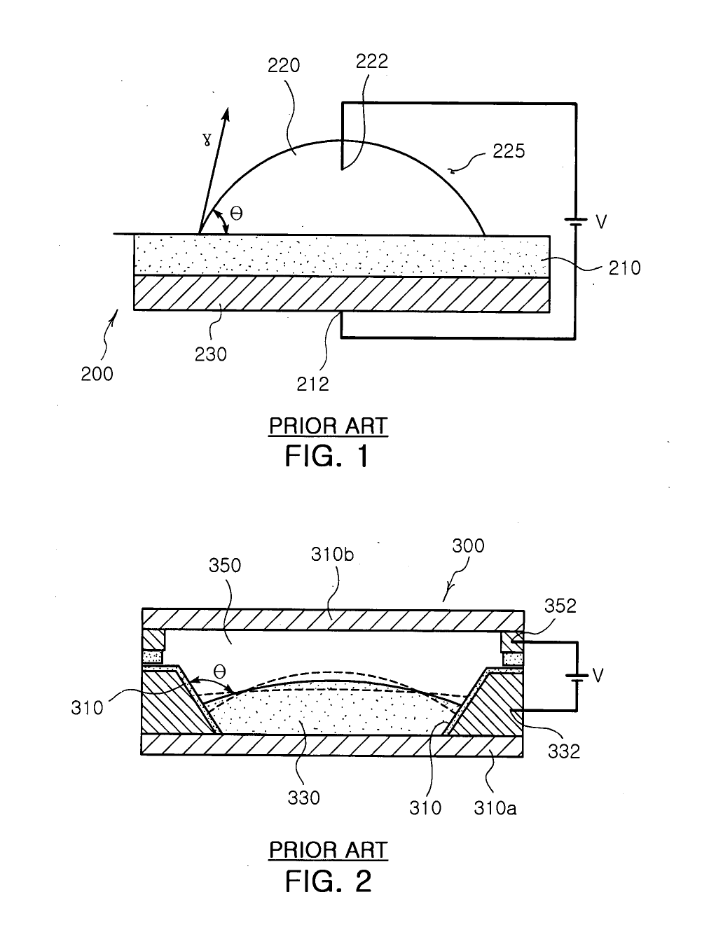

### DETAILED DESCRIPTION OF THE PREFERRED EMBODIMENT

Exemplary embodiments of the present invention will now be described in detail with reference to the accompanying drawings.

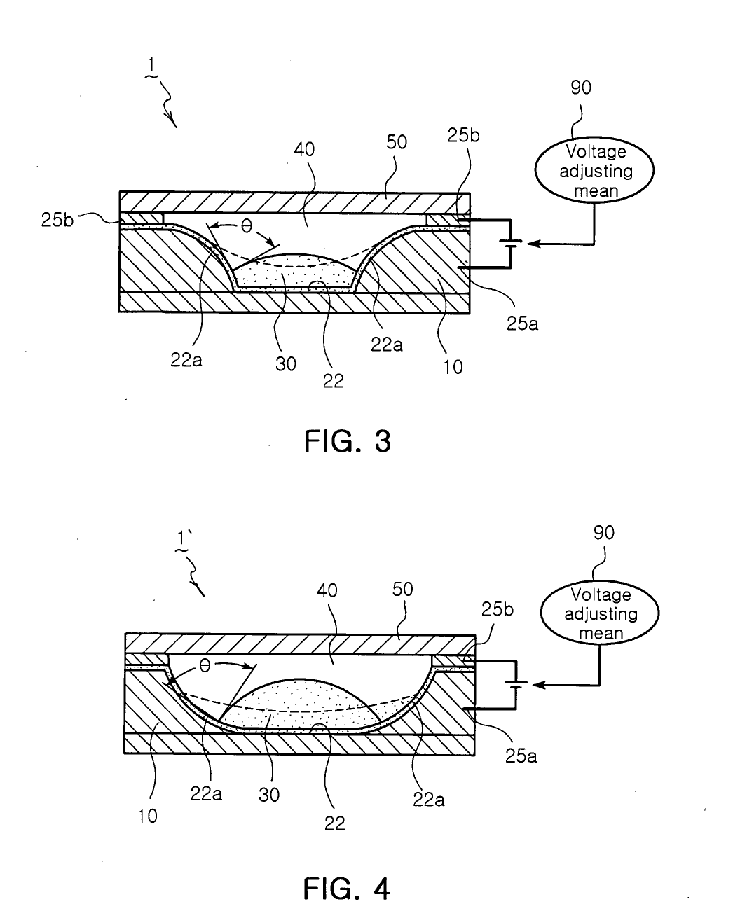

As shown in FIG. 3, a liquid lens 1 having a curved contact surface according to the present invention includes a base 10 which has an insulator film 22 formed thereon and is connected to an electrode 25a.

The base 10 is made of an electrically conductive material and has the insulator film 22 coated in a recess formed in an upper part thereof.

The insulator film 22 should securely insulate a first liquid 30 and a second liquid 40 disposed thereon from the electricity of the electrode 25a connected to the base 10 and is made of a light-transmitting material.

In addition, the first liquid 30 disposed on the base 10, under the second liquid 40 can be a non-conductive fluid or a conductive fluid. In a case where the first liquid 30 is the non-conductive fluid, the second fluid 40 disposed on the first liquid 30 is the conductive fluid. Conversely, if the first liquid 30 is the conductive liquid, the second liquid 40 is the non-conductive liquid.

The first liquid 30 and the second liquid 40 have substantially the same densities.

In addition, preferably according to the present invention, the first liquid 30 and the second liquid 40 are of light-transmitting substance, have different refractive indices, and are non-miscible with each other.

In addition, another electrode 25b is included to supply power to the conductive fluid, according to the present invention.

FIG. 3 exemplifies a case where the second liquid 40 is the conductive fluid and the first liquid 30 is the non-conductive fluid, and the electrode 25b is formed on the cover 50 to supply power to the second liquid 40, which is the conductive liquid.

The electrodes 25a and 25b are connected to a current source supplying a direct current or alternative current of different polarities.

The power applied to the conductive fluid is securely separated from the power applied to the base 10 via the insulator film 22. The insulator film 22 has a contact surface 22a in contact with the first and second liquids 30 and 40.

Meanwhile, according to the present invention, the cover 50 is mounted on an upper part of the base 10 to hermetically seal the first liquid 30 and the second liquid 40. The cover 50 is made of a light-transmitting material, and has the positive electrode 25b formed on a lower part thereof to be electrically connected to an external power source and to supply power to the second fluid 40, which is the conductive fluid, in contact with the cover 50.

In a case where the second fluid 40 is the non-conductive fluid, the electrode 25b will be disposed in a different location to supply power to the first fluid 30, and such a variation in the location of the electrodes can be easily made by a person with ordinary skill in the art, and thus a further explanation is omitted.

In addition, the cover 50 is attached to an upper part of the base 10 to hermetically seal the first liquid 30 and the second liquid 40.

In addition, the base 10 has a curved contact surface 22a in contact with the first and second liquids 30 and 40. FIG. 3 exemplifies a convex contact surface 22a and FIG. 4 exemplifies a concave contact surface 22a.

The contact surface 22a constitutes a portion of the insulator film 22.

In addition, preferably according to the present invention, the contact surface 22a may be composed of both convex and concave surfaces or composed of both curved and planar surfaces.

The unexplained reference numeral 90 denotes a voltage adjusting means for adjusting the magnitude and form of the voltage applied to the negative electrode 25a and the positive electrode 25b.

In the liquid lens 1 having a curved contact surface with the above-described configuration, when the power is supplied through the electrode 25a formed on the base 10 and the electrode 25b formed on the cover 50, the contact angle θ between the second fluid 40, i.e., the conductive fluid and the insulator film 22 is determined by the magnitude of the voltage applied to the electrodes 25a and 25b from the outside. Thereby, the meniscus P is formed in such a shape that the interfacial energy between the first fluid 30 and the second fluid 40 is minimized while the contact angle θ is fixed.

In accordance with the magnitude of the voltage applied, the shape of the meniscus P between the first fluid 30 and the second fluid 40 varies in its curvature, and thereby the liquid lens 1 has different focal distances.

In the structure shown in FIG. 3, the contact surface 22a of the base 10 with the first and second liquids 30 and 40 is a convex surface. In such a structure, when a voltage is applied to the electrodes 25a and 25b, the meniscus P between the first fluid 30 and the second fluid 40 has a smaller curvature than the structure with a planar contact surface 22a.

In this case, as the shape of the meniscus P between the first fluid 30 and the second fluid 40 changes from a shape (indicated by the dotted line) before the voltage is applied to the electrodes 25a and 25b to a different shape (indicated by the solid line) after the voltage is applied, the meniscus P between the first fluid 30 and the second fluid 40 moves (changes) relatively in a small amount per unit time along the contact surface 22a. Thus, in such a structure, the moving speed of the meniscus P is rather slow and the shape of the meniscus P changes insensitively in response to the voltage.

On the contrary, in the structure shown in FIG. 4, the contact surface 22a of the base 10 in contact with the first and second fluids 30 and 40 is a concave surface. In such a structure, when a voltage is applied to the electrodes 25a and 25b, the meniscus P between the first fluid 30 and the second fluid 40 forms a larger curvature than the structure with a planar contact surface 22a.

In this case, as the shape of the meniscus P between the first fluid 30 and the second fluid 40 changes from a shape (indicated by the dotted line) before the voltage is applied to the electrodes 25a and 25b to a different shape (indicated by the solid line) after the voltage is applied, the meniscus P between the first fluid 30 and the second fluid 40 moves (changes) in relatively a large amount per unit time along the contact surface 22a. Thus, in this structure, the moving speed of the meniscus P is rather fast and the shape of the meniscus P changes sensitively in response to the voltage.

Therefore, the shape of the contact surface 22a can be changed to fabricate a liquid lens 1 in which the curvature of the meniscus P changes insensitively or sensitively in response to voltage application.

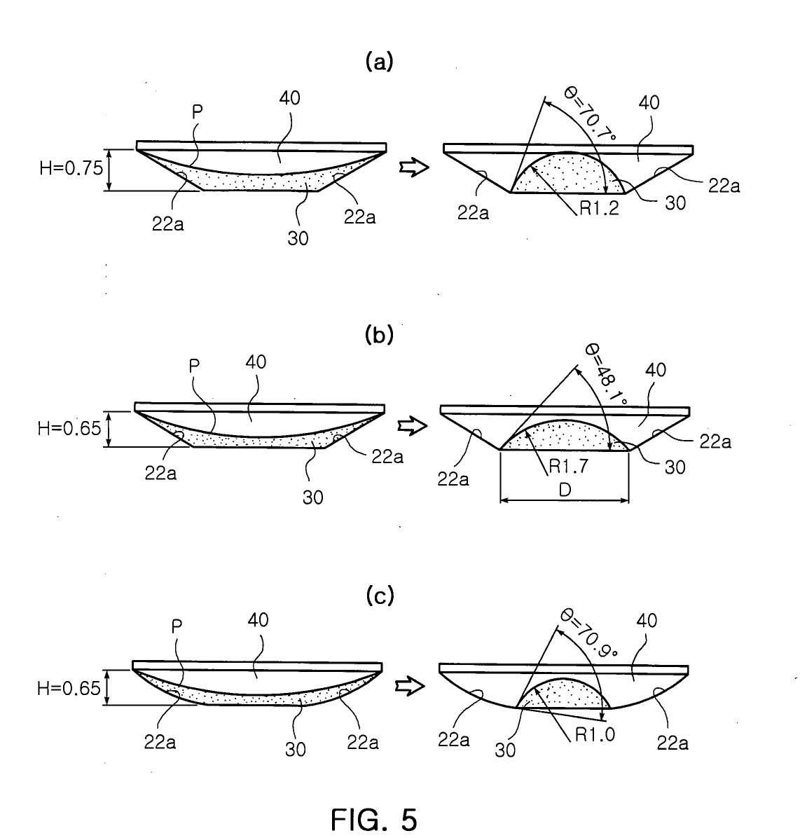

FIG. 5 presents a comparison made between a conventional liquid lens and a liquid lens according to the present invention.

In the conventional structure shown in FIG. 5(a), the height H of the recess, in which the first fluid 30 and the second fluid 40 are contained, is 0.75, and the contact surface 22a is a planar surface. With this configuration, when the voltage is applied to the electrode (not shown), the meniscus P is changed in its shape from the diagram in the left side to the diagram in the right side. Due to this change, the contact angle θ is changed to 70.7° and the radius of curvature of the first fluid 30 is changed to R1.2.

In FIG. 5(b), however, the height H of the liquid lens is reduced to 0.65 while the contact surface 22a is maintained planar. In this case, the base is required to have a larger diameter D in order to contain the same volumes of the first fluid 30 and the second fluid 40 with the reduced height.

With this configuration, when a voltage is applied to the electrode, the meniscus P between the first fluid 30 and the second fluid 40 is changed in its shape from the diagram in the left side to the diagram in the right side. Due to this change, the contact angle θ is changed to 48.1° and the radius of curvature of the first fluid 30 is changed to R1.7.

On the other hand, in FIG. 5(c), the height H of the liquid lens is reduced to 0.65 while the contact surface 22a is formed concave according to the present invention.

With this configuration, when the voltage is applied to the electrode, the meniscus P between the first fluid 30 and the second fluid 40 is changed in its shape from the diagram in the left side to the diagram in the right side. Due to this change, the contact angle θ is changed to 70.9° and the radius of curvature of the first fluid is changed to R1.0.

As seen from this comparison, the present invention allows a reduced height H of the liquid lens from the prior art while the same focal distance is maintained. Such a reduced height is advantageous for miniaturization of a device.

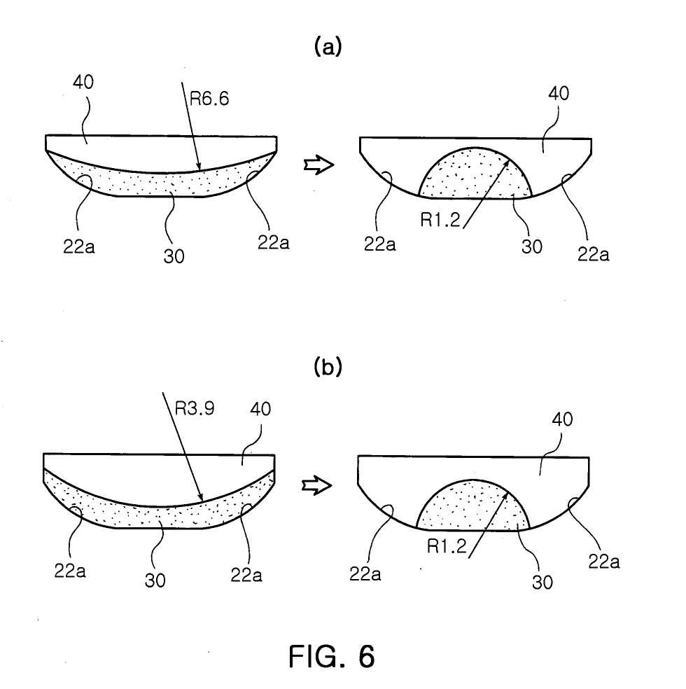

In addition, as shown in FIG. 6, according to the present invention, the curvature of the contact surface 22a can be varied to effectively cope with volume changes of the first fluid 30 and the second fluid 40.

In FIG. 6(a), the contact surface 22a has a combination of a planar surface and a curved surface, and the meniscus P between the first fluid 30 and the second fluid 40 has a radius of curvature of R6.6 before the voltage is applied to the electrode.

After the voltage is applied to change the shape of the meniscus P, the meniscus P between the first fluid 30 and the second fluid 40 has a radius of curvature of R1.2.

On the other hand, in FIG. 6(b), the volumes of the first fluid 30 and the second fluid 40 injected in the liquid lens are increased from those in FIG. 6(a).

In this case, the contact surface 22a can be formed to have a more concave curvature so that the meniscus P between the first fluid 30 and the second fluid 40 maintains the same radius of curvature of R1.2 in response to the same voltage.

Therefore, according to the present invention, even when the volume of the fluids injected into the liquid lens 1 is varied, the curved surface 22a can be configured to have different curvatures to effectively cope with the volume changes of the fluids.

According to the present invention as set forth above, a liquid lens has a curved contact surface of a base so that a curvature of a meniscus is allowed to change sensitively or insensitively in response to a voltage, thereby applicable to various electronic devices that are designed for such characteristics.

In addition, the liquid lens has varying shapes of the contact surface to enable a thin structure with a small thickness, thereby facilitating miniaturization of an electronic device.

Furthermore, even when the volume of the fluids in the liquid lens is changed, the liquid lens can effectively cope with such changes to obtain desired focal distances, thereby enabling more various product designs.

While the present invention has been shown and described in connection with the exemplary embodiments, it will be apparent to those skilled in the art that modifications and variations can be made without departing from the spirit and scope of the invention as defined by the appended claims.

What is claimed is:

1. A liquid lens configured to adjust a focal distance using electro-wetting, comprising:
a base with an insulator film formed thereon and connected to an electrode;
a first fluid disposed on the base;
a second fluid disposed on the first fluid; and
a cover hermetically sealing the first and second fluids and connected to the electrode, the cover made of a light-transmitting material,
wherein a contact surface of the base with the first and second fluids comprises a curved surface.

2. The liquid lens according to claim 1, wherein the contact surface comprises a convex surface.

3. The liquid lens according to claim 1, wherein the contact surface comprises a concave surface.

4. The liquid lens according to claim 1, wherein the contact surface comprises both convex and concave surfaces.

5. The liquid lens according to claim 1, wherein the contact surface comprises both curved and planar surfaces.
